(19) United States
(12) Patent Application Publication
(10) Pub. No.: US 2017/0153014 A1
(43) Pub. Date: Jun. 1, 2017

(54) CABLE LIGHTING SYSTEM

(71) Applicant: DAVINCI OPTO CORP., NEW TAIPEI CITY (TW)

(72) Inventor: Hua-Jung Chiu, New Taipei City (TW)

(21) Appl. No.: 14/952,929

(22) Filed: Nov. 26, 2015

(51) Int. Cl. F21V 21/35; F21V 21/008; F21V 21/002; F21V 21/005; F21V 21/30

(52) U.S. Cl. CPC F21V 21/35; F21V 21/005; F21V 21/30; F21V 21/002; F21V 21/008; F21Y 2105/00

(57) ABSTRACT

A cable lighting system includes two conductive cables and a flat illumination device supported by the two conductive cables. The flat illumination device uses a flat illumination body for providing uniform illumination, which greatly reduces illumination concentration as a convention spot light source does. Furthermore, the flat illumination body is supported by the two conductive cables through two supports disposed spaced at two opposite sides of the flat illumination body. Each support is supported at one point for each conductive cable, so the flat illumination device as a whole is supported by the two conductive cables at the four points and can keep steady easily. Therein, the flat illumination body is pivotally connected to the two supports disposed spaced, so the flat illumination body can be rotated relative to the supports individually for a required orientation without excessive change in the relative disposition of the supports to the conductive cables.

### BACKGROUND OF THE INVENTION

1. Field of the Invention

The invention relates to a lighting system, and especially relates to a cable lighting system.

2. Description of the Prior Art

For conventional cable lighting systems, two electric cables, of which ends usually are fixed on walls, support at least one illumination device and provide electricity thereto. The illumination device usually includes a single supporting structure and a spot light source. The single supporting structure hangs on two electric cables and carries the spot light source. Because of noticeable illumination concentration of spot light, it is difficult to establish uniform illumination onto a larger area even by a plurality of spot light sources.

### SUMMARY OF THE INVENTION

An objective of the invention is to provide a cable lighting system which uses a flat illumination device, of which a flat illumination body is supported by two cables through two supports disposed spaced at two opposite sides of the flat illumination body, for establishing uniform illumination.

A cable lighting system according to the invention includes two conductive cables and a flat illumination device. The two conductive cables are disposed spaced. Each end of the two conductive cables is fixedly disposed, for example on walls. The flat illumination device includes two supports and a flat illumination body. The two supports disposed spaced. Each support is supported by the two conductive cables. The flat illumination body is pivotally connected to and between the two supports. The flat illumination body is electrically connected to the two conductive cables through at least one of the two supports. Because the flat illumination body can provide more uniform illumination than a convention spot light source, the cable lighting system can establish uniform illumination onto a relatively larger area easily. In addition, each support is supported at one point for each conductive cable, so the flat illumination device as a whole is supported by the two conductive cables at the four points and can keep steady easily. Furthermore, the flat illumination body can be rotated relative to the supports individually for a required orientation without excessive change in the relative disposition of the supports to the conductive cables.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a cable lighting system of an embodiment according to the invention.

FIG. 2 is a partially exploded view of a flat illumination device of the cable lighting system in FIG. 1.

FIG. 3 is an exploded view of a flat illumination body of the flat illumination device in FIG. 2.

FIG. 4 is an exploded view of a support of the flat illumination device in FIG. 2.

FIG. 5 is an enlarged section view of a portion of the cable lighting system in FIG. 1.

FIG. 6 is a schematic diagram illustrating a cable lighting system of another embodiment according to the invention.

FIG. 7 is a partially exploded view of the cable lighting system in FIG. 6.

FIG. 8 is an exploded view of a support of a flat illumination body of the cable lighting system in FIG. 6.

FIG. 9 is a top view of the cable lighting system in FIG. 6.

### DETAILED DESCRIPTION

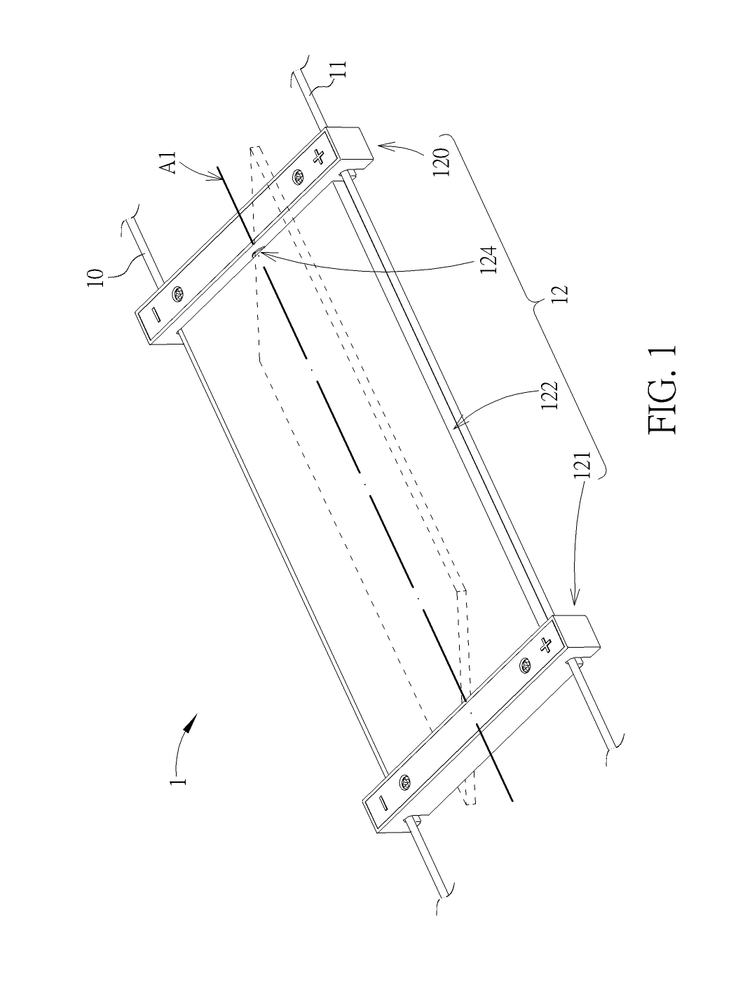

Please refer to FIG. 1. FIG. 1 is a schematic diagram illustrating a cable lighting system 1 of an embodiment according to the invention. The cable lighting system 1 can be used for indoor illumination and includes two conductive cables 10 and 11 and a flat illumination device 12. The two conductive cables 10 are disposed spaced and extend in a direction D1. Both ends of each conductive cable 10 and 11 are fixedly disposed, for example on walls. The flat illumination device 12 includes two supports 120 and 121 and a flat illumination body 122. The two supports 120 and 121 are disposed spaced. Each support 120 and 121 is supported by the two conductive cables 10 and 11. The flat illumination body 122 is pivotally connected to and between the two supports 120 and 121, so that the flat illumination body 122 hangs on the two conductive cables 10 and 11 through the two supports 120 and 121 (at two opposite sides of the flat illumination body 122) and can rotate relative to the two conductive cables 10 and 11 (as shown in dashed lines). The two conductive cables 10 and 11 carry electricity for providing a voltage (or electric potential difference) required by the flat illumination body 122. The flat illumination body 122 is electrically connected to the two conductive cables 10 and 11 through at least one of the two supports 120 and 121, so that the flat illumination body 122 can be powered to emitting light.

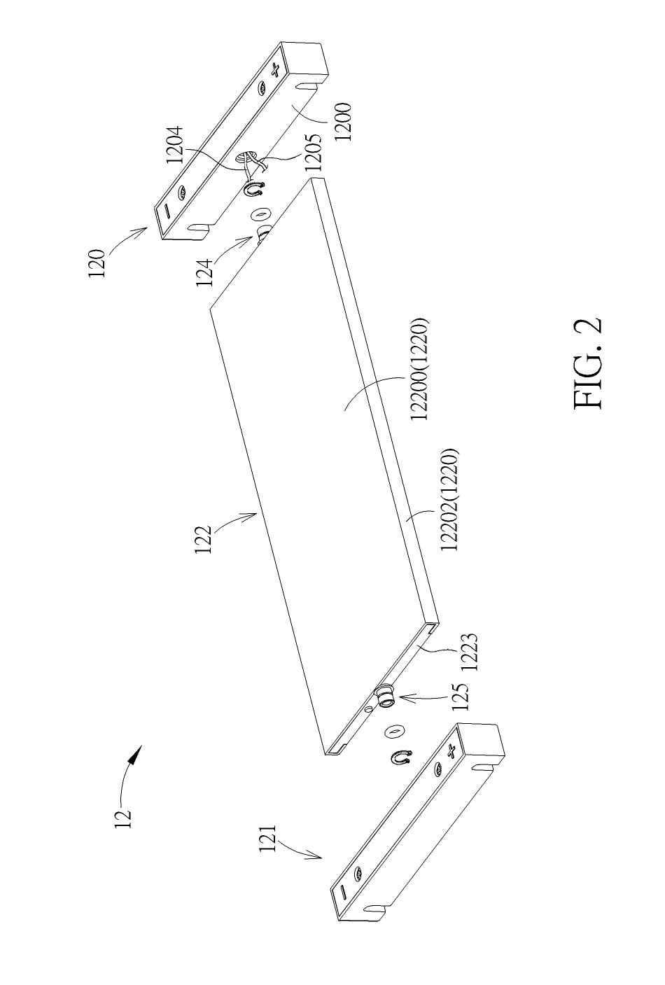

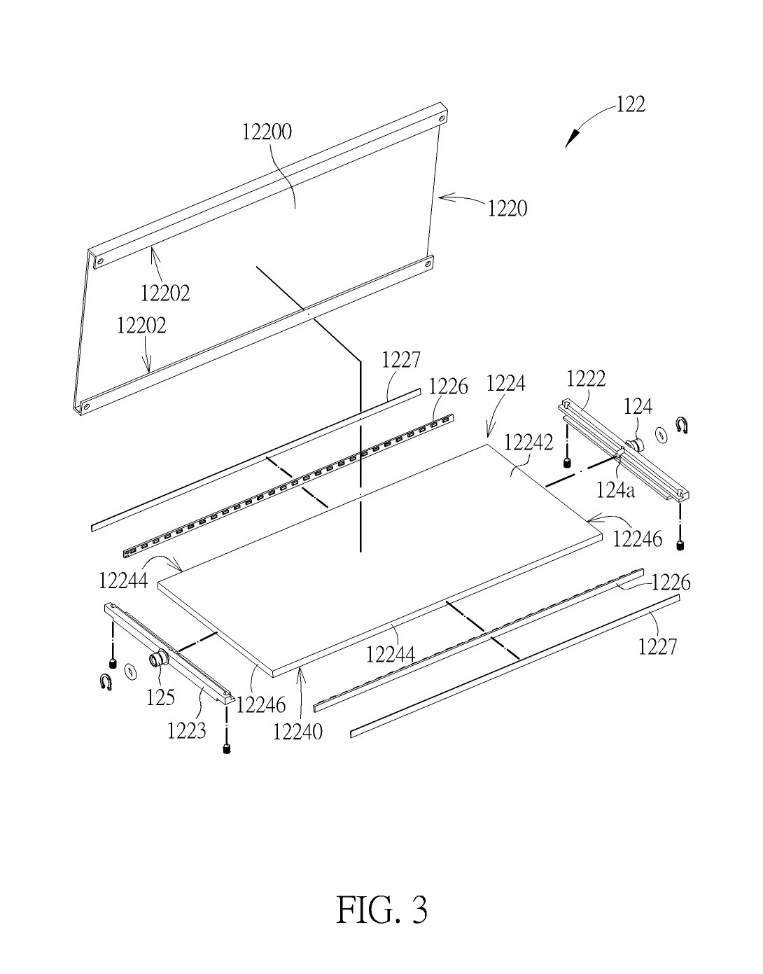

Please also refer to FIG. 2 to FIG. 3. FIG. 2 is a partially exploded view of the flat illumination device 12. FIG. 3 is an exploded view of the flat illumination body 122. In the embodiment, the flat illumination body 122 includes a back cover 1220, two opposite side frames 1222 and 1223, a light guiding plate 1224, and two light bars 1226. The back cover 1220 has a back portion 12200 and two side slots 12202 disposed at two opposite sides of the back portion 12200. The two side frames 1222 and 1223 are connected to the back cover 1220 at another two opposite sides of the back portion 12200 respectively. The back cover 1220 and the side frames 1222 and 1223 substantially form a recess for receiving the light guiding plate 1224 and the two light bars 1226. The flat illumination body 122 is pivotally connected to the two supports 120 and 121 through the two opposite side frames 1222 and 1223 respectively. In the embodiment, the back cover 1220 can be an integrated part formed by pressing a metal plate, but the invention is not limited thereto. For example, the back cover 1220 can be an assembly of several components.

The light guiding plate 1224 has a light-emitting surface 12240, a back surface 12242 opposite to the light-emitting surface 12240, and two edge portions 12244 at two opposite sides of the light-emitting surface 12240. The two edge portions 12244 are disposed in the two side slots 12202 respectively. The back surface 12242 is toward the back portion 12200. The two light bars 1226 are disposed in the two side slots 12202 toward the corresponding edge portions 12244 respectively. Thereby, light produced by the light bars 1226 can enter the light guiding plate 1224 from the edge portions 12244 and then is emitted out of the light guiding plate 1224 from the light-emitting surface 12240. For enhancement of emitting efficiency, it is practicable to dispose a reflection layer or sheet between the back surface 12242 and the back portion 12200 (e.g. on the back surface 12242 or on the surface of the back portion 12200 facing the back surface 12242). In addition, in the embodiment, each light bar 1226 is attached into the corresponding slot 12202 through a heat conductive adhesive or tape 1227, which is conducive to dissipating heat produced by the light bars 1226 in operation through the back cover 1220.

In the embodiment, each side frame 1223 has a step. Another two edge portions 12246 of the light guiding plate 1224 are disposed on the steps. In other words, the circumference of the light guiding plate 1224 is held by the two side slots 12202 of the back cover 1220 and the two steps of the two side frames 1223, which is conducive to the fixity of the light guiding plate 1224. In addition, in the embodiment, the flat illumination body 122 is pivotally connected to the two supports 120 and 121 through two pivots 124 and 125 respectively. The pivots 124 and 125 are integrated into the side frames 1222 and 1223 respectively, but the invention is not limited thereto. For example, the pivots 124 and 125 are integrated into the supports 120 and 121 respectively, or the pivots 124 and 125 are individual parts. Therefore, the two side frames 1222 and 1223 are pivotally connected to the two supports 120 and 121 through the two pivots 124 and 125 respectively.

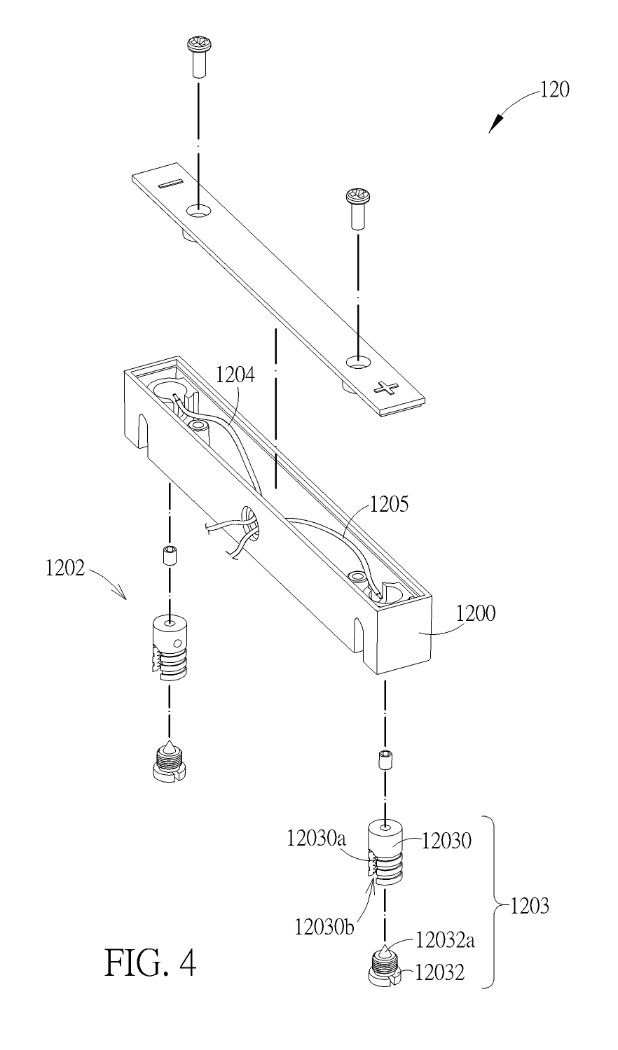

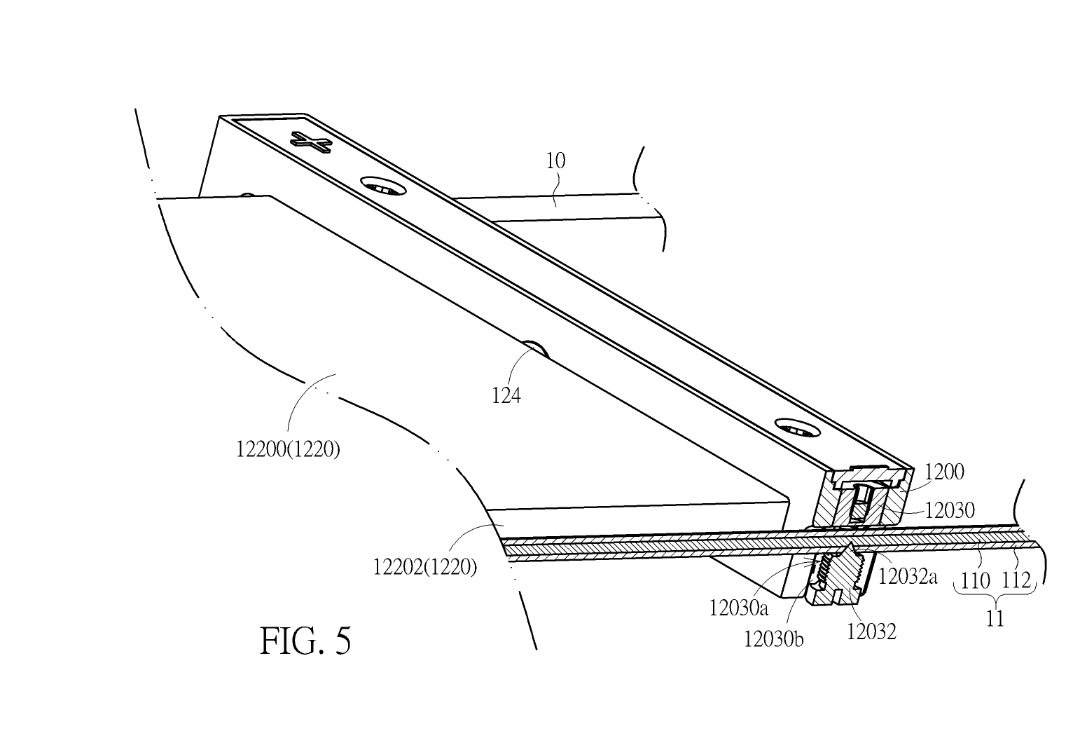

Please also refer to FIG. 4 and FIG. 5. FIG. 4 is an exploded view of the support 120. FIG. 5 is an enlarged section view of a portion of the cable lighting system 1. In the embodiment, the support 120 includes a structural member 1200, two electrical joining members 1202 and 1203, and two conducting parts 1204 and 1205. The support 120 is pivotally connected to the corresponding side frame 1222 through the structural member 1200. The structural member 1200 is achieved by a casing capable of accommodating other components therein, such as the electrical joining members 1202 and 1203 and the conducting parts 1204 and 1205. The structural member 1200 has a pivot hole engaging with the pivot 124, so that the structural member 1200 is pivotally connected to the corresponding side frame 1222 through the pivot 124.

The two electrical joining members 1202 and 1203 are fixedly disposed on the structural member 1200 and electrically join the two conducting parts 1204 and 1205 with the two conductive cables 10 and 11 respectively. The electrical joining member 1203 includes a conductive main body 12030 and a conductive screw 12032. The conductive main body 12030 is fixedly disposed on the structural member 1200 and has a thread hole 12030a and an open slot 12030b passing through the thread hole 12030a. The corresponding conductive cable 11 passes through the open slot 12030b. The conductive screw 12032 is screwed into the thread hole 12030a to fix the corresponding conductive cable 11 in the open slot 12030b and electrically connected with the corresponding conductive cable 11. In the embodiment, the conductive screw 12032 has a sharp tip 12032a. The sharp tip 12032a pricks the corresponding conductive cable 11. Thereby, the sharp tip 12032a contributes the fixing of the corresponding conductive cable 11 in the open slot 12030b and the electrical connection of the corresponding conductive cable 11 with the conductive main body 12030. Furthermore, in the embodiment, the corresponding conductive cable 11 includes a central conductor 110 and an insulation jacket 112. The central conductor 110 is sheathed with the insulation jacket 112. The conductive screw 12032 pricks the insulation jacket 112 with the sharp tip 12032a and then contacts the central conductor 110. In addition, for a case that the corresponding conductive cable 11 is a bare cable, the conductive screw 12032 without the sharp tip 12032a still can clamp the corresponding conductive cable 11 in the open slot 12030b firmly.

The two conducting parts 1204 and 1205 are disposed on the structural member 1200. The conducting part 1205 is electrically connected to the electrical joining member 1203 by attaching one end of the conducting part 1205 to the conductive main body 12030 of the electrical joining member 1203. The attachment is achieved by a similar way to that for electrically connecting the cable 11 with the electrical joining member 1203; however, the invention is not limited thereto. For example, the end of the conducting part 1205 can be soldered onto the conductive main body 12030, or the end of the conducting part 120 wraps around a post or screw attached the conductive main body 12030, or the end of the conducting part 1205 is clamped by a clip attached the conductive main body 12030. In addition, in the embodiment, the conducting part 1205 is a conductive wire, but the invention is not limited thereto. For example, the conducting part 1205 can be a bare wire, or a conductive part embedded in the structural member 1200 (e.g. by an insert molding process used for forming the structural member 1200). The two conducting parts 1204 and 1205 are also electrically connected to the flat illumination body 122. In the embodiment, the pivot 124 has a through hole 124a, which the conducting parts 1204 and 1205 pass through into the flat illumination body 122 for electrically connecting with at least one light bar 1226. In addition, in the embodiment, the light bars 1226 use LEDs mounted on a circuit board as lighting source. The conductive cables 10 and 11 carry low voltage about 12V. However, the invention is not limited thereto. In practice, what kind of voltage the conductive cables 10 and 11 carry depends on what the flat illumination devices 1 needs or more exactly what the light bars 1226 need. Furthermore, the conductive cables 10 and 11 are not limited to be identical. For example, one is a cable with sheath while the other is a bare cable.

In addition, in the embodiment, the two electrical joining members 1202 and 1203 are the same, the conducting parts 1204 and 1205 are the same, and the conductive cables 10 and 11 have the same structure. For the details of the electrical joining member 1202, the conductive cable 10, and the conducting part 1204, please refer to the relevant description of the electrical joining member 1203, the conductive cable 11, and the conducting part 1205 respectively and will not be described repeatedly. However, the invention is not limited thereto. In addition, the electrical joining member according to the invention is not limited to the above electrical joining member 1203. For example, an electrical joining member according to the invention can use a conductive clip to clip a conductive cable (e.g. a bare conductive cable), which also can achieve the purposes of fixing the support on the conductive cable and electrically connecting the electrical joining member with the conductive cable.

In addition, in the embodiment, the supports 120 and 121 are substantially symmetrical, so the details of the support 121 can be understood by referring to the relevant description of the support 120 and will not be described repeatedly. In the embodiment, the two lighting bars 1226 are powered through the supports 120 and 121 respectively. However, the invention is not limited to the fact that the supports 120 and 121 are substantially symmetrical. For example, the support 120 can be used for providing supporting and electricity to the flat illumination body 122 while the support 121 can be used only for supporting the flat illumination body 122 without supply of electricity. In this case, the support 121 can be provided without conducting parts (such as the conducting parts 1204 and 1205) and can be realized by a rod part with a clip at each end thereof for clipping the two conductive cables 10 and 11.

Furthermore, in the embodiment, each support 120 and 121 shows a straight bar, so when the supports 120 and 121 are installed onto the conductive cables 10 and 11 by their end portions, the flat illumination device 1 and the conductive cables 10 and 11 are disposed on the same plane in logic and the flat illumination body 122 is located between the two conductive cables 10 and 11. In another aspect, the flat illumination body 122 and the two cables 10 and 11 are substantially coplanarly disposed, and the flat illumination body 122 is between the conductive cables 10 and 11. Therefore, the cable lighting system 1 occupies less space than a conventional cable lighting system of which a spot light source is much lower than cables. In practice, such feature makes the flat illumination device 12 capable of being used like an embedded ceiling light when the conductive cables 10 and 11 are disposed close to a ceiling.

In addition, the two side frames 1222 and 1223 are pivotally connected to the two supports 120 and 121 in an axis A1 (indicated by a center line) parallel to the direction D1 in which the two conductive cables 10 and 11 extend. When the flat illumination body 122 shows a rectangle profile of which the long side is parallel to the axis A1, a rotation adjustment operation on the flat illumination body 122 (e.g. rotating the flat illumination body 122 about the axis A1 for a required orientation) involves a smaller space. Furthermore, the supports 120 and 121 is located at two opposite sides of the flat illumination device 12, so a user can easily arrange a plurality of flat illumination devices 1 one after another in a row on the conductive cables 10 and 11 without interference with each other. By the arrangement of the flat illumination devices 1, a uniform illumination extension can be easily obtained.

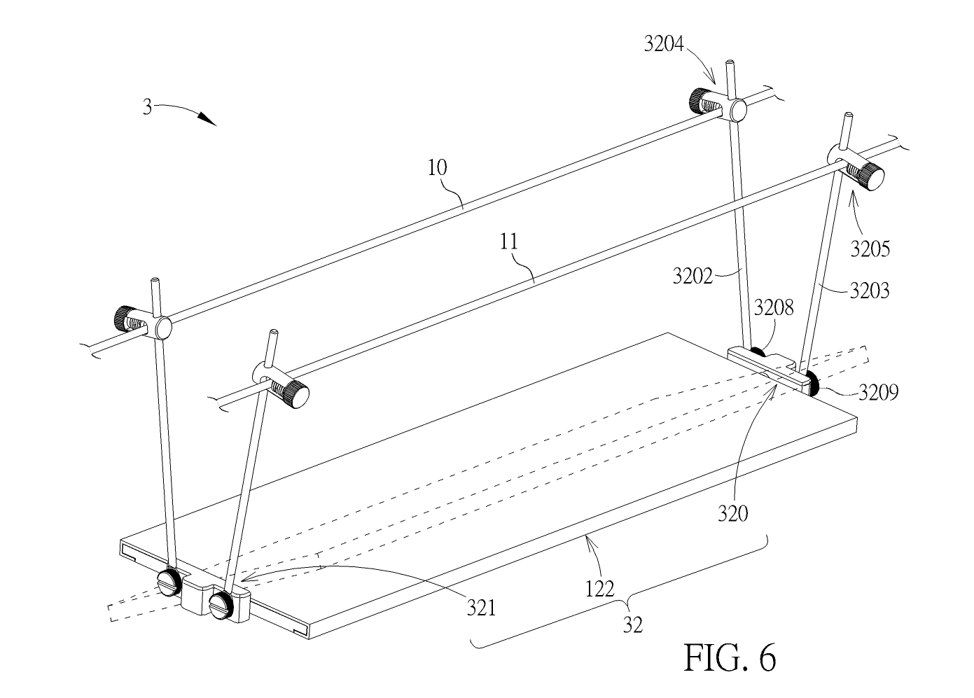

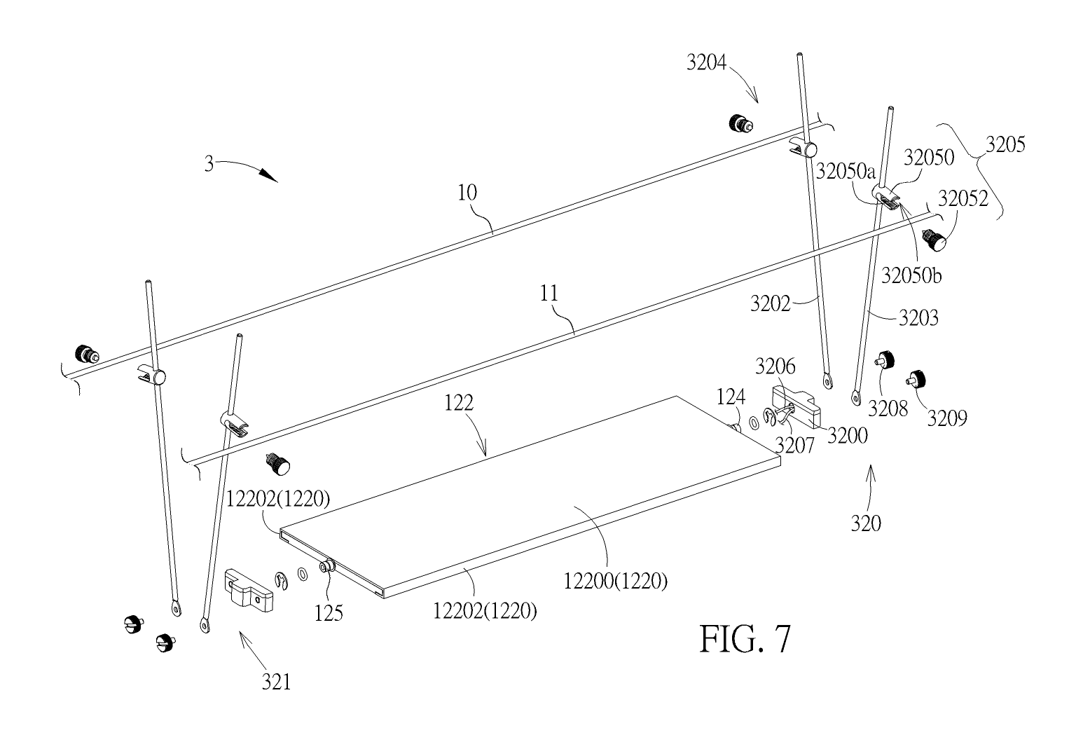

As discussed above, the flat illumination device 1 and the conductive cables 10 and 11 are substantially coplanarly disposed, but the invention is not limited thereto. Please refer to FIG. 6 and FIG. 7. FIG. 6 is a schematic diagram illustrating a cable lighting system 3 of another embodiment according to the invention. FIG. 7 is a partially exploded view of the cable lighting system 3. In the embodiment, the cable lighting system 3 is logically similar to the cable lighting system 1. For simplification of the cable lighting system 3, the cable lighting system 3 is illustrated with the same reference numbers used in the cable lighting system 1 for the same components. For other descriptions about these components, please refer to the relevant descriptions of the components with the same reference numbers in the cable lighting system 1. In the embodiment, the cable lighting system 3 includes two conductive cables 10 and 11 and a flat illumination device 32. The flat illumination device 32 includes two supports 320 and 321 and a flat illumination body 122. The flat illumination body 122 is pivotally connected to the two supports 320 and 321 through pivots 124 and 125 respectively. Each of the two supports 320 and 321 is supported by the two conductive cables 10 and 11. Thereby, the flat illumination body 122 hangs on the two conductive cables 10 and 11 through the two supports 320 and 321 and can rotate relative to the two conductive cables 10 and 11 (as shown in dashed lines).

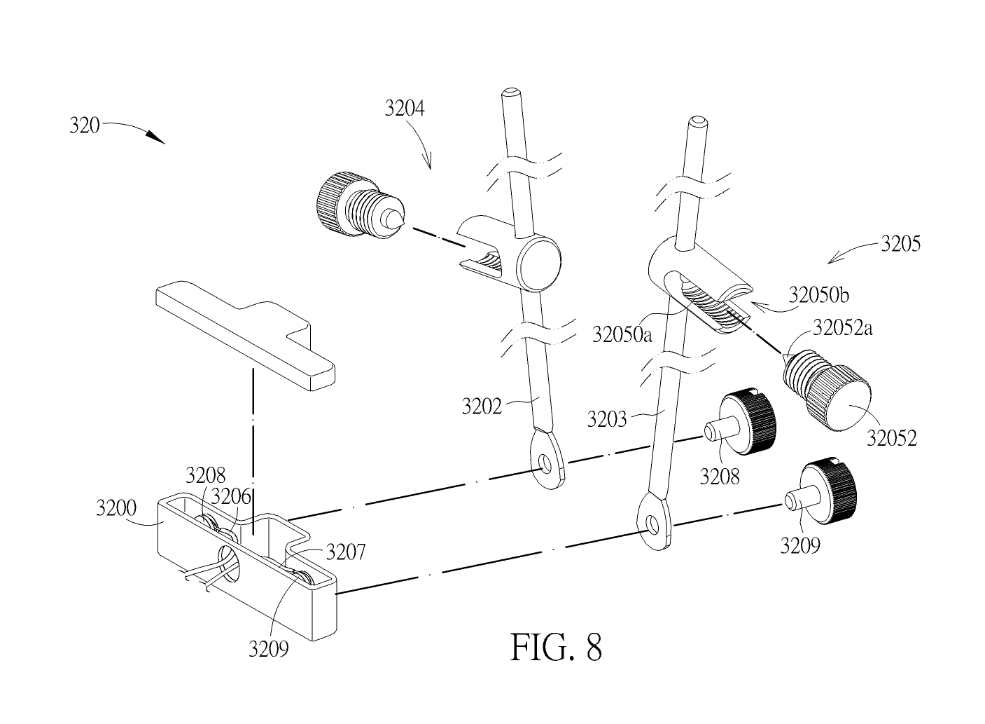

Please also refer to FIG. 8. FIG. 8 is an exploded view of the support 320. The support 320 includes a structural member 3200, two conductive extension members 3202 and 3203, two electrical joining members 3204 and 3205, and two conducting parts 3206 and 3207. The support 320 is pivotally connected to the corresponding side frame 1222 through the structural member 3200. The structural member 3200 is achieved by a casing capable of accommodating other components therein, such as the conducting parts 3206 and 3207. The structural member 3200 has a pivot hole engaging with the pivot 124, so that the structural member 3200 is pivotally connected to the corresponding side frame 1222 through the pivot 124. The two conductive extension members 3202 and 3203 are connected to the structural member 3200. The two electrical joining members 3204 and 3205 electrically join the two conductive extension members 3202 and 3203 with the two conductive cables 10 and 11 respectively. Thereby, the support 320 is supported by the two conductive cables 10 and 11 through the two electrical joining members 3204 and 3205.

In the embodiment, the electrical joining member 3205 is fixedly connected to the corresponding conductive extension member 3203 and includes a conductive main body 32050 and a conductive screw 32052. The conductive main body 32050 has a thread hole 32050a and an open slot 32050b passing through the thread hole 32050a. The corresponding conductive cable 11 passes through the open slot 12030b. The conductive screw 32052 is screwed into the thread hole 32050a to fix the corresponding conductive cable 11 in the open slot 32050b and electrically connected with the corresponding conductive cable 11. In the embodiment, the conductive screw 32052 has a sharp tip 32052a. The sharp tip 32052a pricks the corresponding conductive cable 11. Thereby, the sharp tip 32052a contributes the fixing of the corresponding conductive cable 11 in the open slot 32050b and the electrical connection of the corresponding conductive cable 11 with the conductive main body 32050. For a case that the corresponding conductive cable 11 includes a central conductor 110 sheathed with an insulation jacket 112, the conductive screw 32052 pricks the insulation jacket 112 with the sharp tip 32052a and then contacts the central conductor 110. For another case that the corresponding conductive cable 11 is a bare cable, the conductive screw 32052 without the sharp tip 32052a still can clamp the corresponding conductive cable 11 in the open slot 32050b firmly. In addition, the electrical joining member according to the invention is not limited to the above electrical joining member 3205. For example, an electrical joining member according to the invention can use a conductive clip to clip a conductive cable (e.g. a bare conductive cable), which also can achieve the purposes of fixing the support on the conductive cable and electrically connecting the electrical joining member with the conductive cable.

In the embodiment, the conductive extension member 3203 is a metal rod. The conductive main body 32050 has a through hole 32050c. The corresponding conductive extension member 3203 passes through the through hole 32050c for fixing the electrical joining member 3205 thereon. The location of the conductive main body 32050 on the conductive extension member 3203 can be adjusted by sliding the conductive main body 32050 relative to the conductive extension member 3203. In practice, the conductive extension member 3203 can be joined with the electrical joining member 3205 by a similar way to that for electrically connecting the cable 11 with the electrical joining member 3205; however, the invention is not limited thereto. For example, the conductive extension member 3203 and the electrical joining member 3205 are joined by a screw and a thread hole engaging with each other. For example, the through hole 32050c can be implemented by a rotatable nut (of which a thread hole functions as the through hole 32050c) disposed on the conductive main body 32050. Correspondingly, the conductive extension member 3203 has a threaded portion engaging with the rotatable nut. By rotating the nut, the conductive main body 32050 can move along the conductive extension member 3203. In other words, the location of the flat illumination body 122 relative to the two conductive cables 10 and 11 is adjustable.

In the embodiment, the two conducting parts 3206 and 3207 are disposed on the structural member 3200 and are electrically connected to the two conductive extension members 3202 and 3203 through two conducting posts 3208 and 3209 respectively. Each conducting post 3208 and 3209 includes a mounted boss with a thread hole, and a fixing screw. The conducting posts 3208 and 3209 pass through a side wall of the structural member 3200 so that two ends of the conducting parts 3206 and 3207 are connected to the conducting posts 3208 and 3209 inside respectively (for example by wrapping around the posts 3208 and 3209) and two ends of the conductive extension members 3202 and 3203 are connected to conducting posts 3208 and 3209 outside respectively (further with a fixing part for fixing the two ends on the posts 3208 and 3209). In the embodiment, the two conducting parts 3206 and 3207 are conductive wires, but the invention is not limited thereto. For example, the conducting parts 3206 and 3207 can be bare wires, or conductive parts embedded in the structural member 3200 (e.g. by an insert molding process used for forming the structural member 3200). In the embodiment, the two conducting parts 3206 and 3207 are also electrically connected to the flat illumination body 122. The conducting parts 3206 and 3207 pass through the through hole 124a of the pivot 124 into the flat illumination body 122 for electrically connecting with at least one light bar 1226.

In addition, in the embodiment, the supports 320 and 321 are substantially symmetrical, so the details of the support 321 can be understood by referring to the relevant description of the support 320 and will not be described repeatedly. In the embodiment, the two lighting bars 1226 are powered through the supports 320 and 321 respectively. However, the invention is not limited to the fact that the supports 320 and 321 are substantially symmetrical. For example, the support 320 can be used for providing supporting and electricity to the flat illumination body 122 while the support 321 can be used only for supporting the flat illumination body 122 without supply of electricity. In this case, the support 321 can be provided without conducting parts (such as the conducting parts 3206 and 3207) and can be realized by a pivotal part and two extension members connected to the pivotal part. A clip is provided at each end of the two extension members for clipping the two conductive cables 10 and 11.

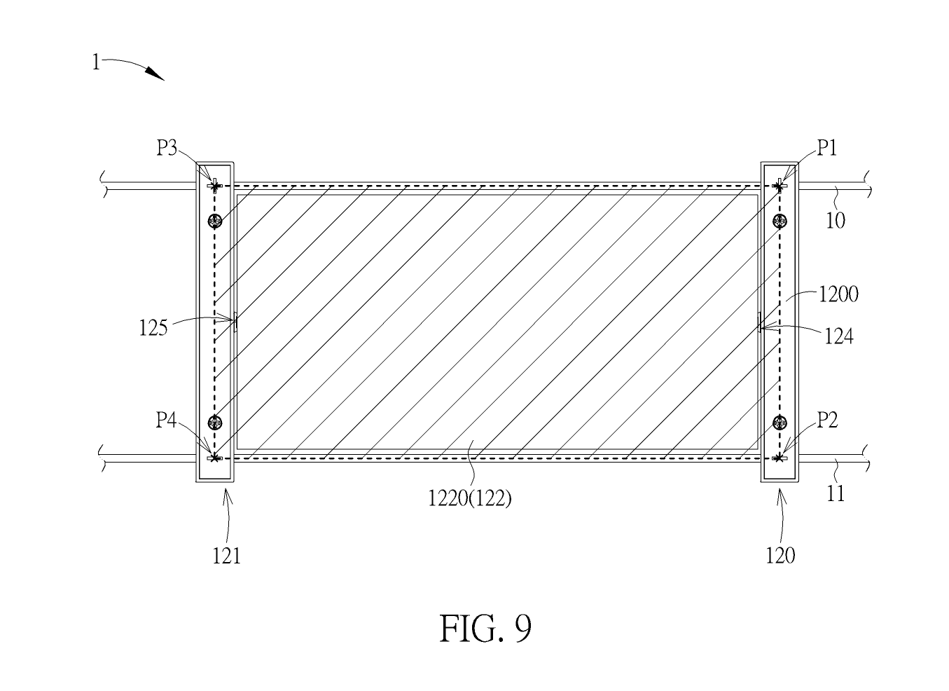

In the above embodiment, the flat illumination devices 12 and 32 hang on the conductive cables 10 and 11 by four points, so the structural stability is better than that of a convention spot light source which hangs on cable lights usually by two points. For more details, please also refer to FIG. 9 which is a top view of the cable lighting system 1.

A plane is defined, on which the two conductive cables 10 and 11 are located. The view plane of FIG. 9 can be considered as the plane for simplification of illustration. The electrical joining members of the two supports 320 and 321 connect with four points P1, P2, P3 and P4 (indicated by cross marks) of the two conductive cables 10 and 11. The four points P1, P2, P4 and P3 form an area (presented by a polygon in dashed lines with hatch lines inside) on the plane parallel to the two conductive cables 10 and 11. A profile projection of the flat illumination body 122 on the plane is within the area. When the flat illumination device 12 is vertical hanged on the conductive cables 10 and 11, the line of gravity of the flat illumination device 12 will always pass through the area even with change in the gravity of the flat illumination device 12 (for example due to a rotation). In another aspect, a change in the gravity of the flat illumination device 12 may induce a new state of equilibrium (involving new balanced forces at the four points P1, P2, P3 and P4), but no torque (or moment) is produced at the four points P1, P2, P3 and P4 in principle. The above feature also exists in the cable lighting system 3. Therefore, the flat illumination devices 12 and 32 can be stably supported when vertically hanging on the conductive cables 10 and 11.

In addition, in the cable lighting system 1 (referring to FIG. 1), the two supports 120 and 121 are connected to the side frames 1222 and 1223 individually. That is, each support 120 and 122 can be rotate relative to the flat illumination body 122 individually. For a case that the conductive cables 10 and 11 are a little non-parallel, supports 120 and 121 can adapt to the non-parallel problem by being rotated relative to the conductive cables 10 and 11 individually, so that the flat illumination body 122 can remain its original orientation. The above feature also exists in the cable lighting system 3. The adaptation of the supports 320 and 321 to the proper non-parallel problem of the conductive cables 10 and 11 can be understood by referring to the above description and will not be repeated in addition.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A cable lighting system, comprising:
two conductive cables disposed spaced, each end of the two conductive cables being fixedly disposed; and
a flat illumination device comprising:
two supports disposed spaced, each support being supported by the two conductive cables; and
a flat illumination body pivotally connected to and between the two supports, the flat illumination body being electrically connected to the two conductive cables through at least one of the two supports.

2. The cable lighting system of claim 1, wherein one of the supports comprises a structural member, two electrical joining members, and two conducting parts, the support is pivotally connected to the flat illumination body through the structural member, the two electrical joining members are fixedly disposed on the structural member and electrically join the two conducting parts with the two conductive cables respectively, and the two conducting parts are disposed on the structural member and electrically connected to the flat illumination body.

3. The cable lighting system of claim 2, wherein one of the electrical joining members comprises a conductive main body and a conductive screw, the conductive main body is fixedly disposed on the structural member and has a thread hole and an open slot passing through the thread hole, the corresponding conductive cable passes through the open slot, and the conductive screw is screwed into the thread hole to fix the corresponding conductive cable in the open slot and electrically connected with the corresponding conductive cable.

4. The cable lighting system of claim 3, wherein the corresponding conductive cable comprises a central conductor and an insulation jacket, the central conductor is sheathed with the insulation jacket, and the conductive screw has a sharp tip and pricks the insulation jacket with the sharp tip and then contacts the central conductor.

5. The cable lighting system of claim 2, wherein the structural member is pivotally connected to the flat illumination body through a pivot, the pivot has a through hole, and the two conducting parts pass through the through hole into the flat illumination body.

6. The cable lighting system of claim 1, wherein the flat illumination body and the two cables are substantially coplanarly disposed, and the flat illumination body is between the conductive cables.

7. The cable lighting system of claim 1, wherein one of the supports comprises a structural member, two conductive extension members, two electrical joining members, and two conducting parts, the support is pivotally connected to the flat illumination body through the structural member, the two conductive extension members are connected to the structural member, the two electrical joining members electrically join the two conductive extension members with the two conductive cables respectively, the support is supported by the two conductive cables through the two electrical joining members, the two conducting parts are disposed on the structural member and are electrically connected to the two conductive extension members respectively, and the two conducting parts are electrically connected to the flat illumination body.

8. The cable lighting system of claim 7, wherein one of the electrical joining members comprises a conductive main body and a conductive screw, the conductive main body is fixedly connected to the corresponding conductive extension member and has a thread hole and an open slot passing through the thread hole, the corresponding conductive cable passes through the open slot, and the conductive screw is screwed into the thread hole to fix the corresponding conductive cable in the open slot and electrically connect with the corresponding conductive cable.

9. The cable lighting system of claim 8, wherein the corresponding conductive cable comprises a central conductor and an insulation jacket, the central conductor is sheathed with the insulation jacket, and the conductive screw has a sharp tip and pricks the insulation jacket with the sharp tip and contacts the central conductor.

10. The cable lighting system of claim 7, wherein the structural member is pivotally connected to the flat illumination body through a pivot, the pivot has a through hole, and the two conducting parts pass through the through hole into the flat illumination body.

11. The cable lighting system of claim 7, wherein the conductive extension members is two metal rods.

12. The cable lighting system of claim 1, wherein the two conductive cables extend in a direction, and the flat illumination body is pivotally connected to the two supports in an axis parallel to the direction.

13. The cable lighting system of claim 1, wherein the flat illumination body comprises a back cover, two opposite side frames, a light guiding plate, and a light bar, the back cover has a back portion and two side slots disposed at two opposite sides of the back portion, the light guiding plate has a light-emitting surface, a back surface opposite to the light-emitting surface, and two edge portions at two opposite sides of the light-emitting surface, the two edge portions are disposed in the two side slots respectively, the back surface is toward the back portion, the two opposite side frames are connected to the back cover at another two opposite sides of the back portion respectively, the flat illumination body is pivotally connected to the two supports through the two opposite side frames respectively, and the light bar is disposed in one of the side slots toward the corresponding edge portion.

14. The cable lighting system of claim 1, wherein the two supports connect with four points of the two conductive cables, the four points form an area on a plane parallel to the two conductive cables, and a profile projection of the flat illumination body on the plane is within the area.
